(19) United States
(12) Patent Application Publication
(10) Pub. No.: US 2017/0327110 A1
(43) Pub. Date: Nov. 16, 2017

(54) DRIVING ASSISTANCE CONTROL DEVICE FOR VEHICLE

(71) Applicants: TOYOTA JIDOSHA KABUSHIKI KAISHA, Toyota-shi (JP); National University Corporation Tokyo University of Agriculture and Technology, Tokyo (JP); The University of Tokyo, Tokyo (JP)

(72) Inventors: Shintaro INOUE, Kanagawa-ken (JP); Hideo INOUE, Kanagawa-ken (JP); Pongsathorn RAKSINCHAROENSAK, Tokyo (JP); Yuichi SAITO, Tokyo (JP); Masao NAGAI, Tokyo (JP); Takuma ITO, Tokyo (JP); Tsukasa SHIMIZU, Nagkute-shi (JP)

(73) Assignees: TOYOTA JIDOSHA KABUSHIKI KAISHA, Toyota-shi (JP); National University Corporation Tokyo University of Agriculture and Technology, Tokyo (JP); The University of Tokyo, Tokyo (JP)

(21) Appl. No.: 15/591,595

(22) Filed: May 10, 2017

(30) Foreign Application Priority Data
May 16, 2016 (JP) 2016-097596

(51) Int. Cl. B60W 30/09; B60W 40/02; B60W 10/18; G08G 1/16; B60W 10/20; B60W 50/14; G01S 19/13

(52) U.S. Cl. CPC B60W 30/09; B60W 10/20; B60W 40/02; B60W 50/14; B60W 10/18; G08G 1/166; B60W 2520/125; B60W 2510/20; B60W 2510/18; B60W 2420/52; B60W 2050/146; B60W 2520/14; B60W 2550/10; B60W 2550/406; B60W 2710/18; B60W 2710/20; G01S 19/13

(57) ABSTRACT

A driving assistance control device for a vehicle includes: a moving object detection sensor configured to detect a moving object moving along a roadside in a traveling direction of the vehicle; a driving operation detection sensor configured to detect a driving operation of a driver; an actuator; and an Electronic Control Unit configured to perform automatic steering control of the vehicle by the actuator to avoid the moving object based on a detection result of the moving object, the Electronic Control Unit being configured to start the automatic steering control based on a driving steering of the driver after the moving object is detected.

### INCORPORATION BY REFERENCE

The disclosure of Japanese Patent Application No. 2016-097596 filed on May 16, 2016 including the specification, drawings and abstract is incorporated herein by reference in its entirety.

### BACKGROUND

### 1. Technical Field

The present disclosure relates to a driving assistance control device for a vehicle.

### 2. Description of Related Art

A driving assistance system for avoiding collision with a moving object, which is detected in the direction in which a vehicle is traveling, has been proposed in various modes. For example, Japanese Patent Application Publication No. 2009-286279 (JP 2009-286279 A) discloses a configuration in which, when an object is detected in front of a traveling vehicle, traveling control is performed in such a way that a lateral movement amount of the host vehicle for avoiding the object is set according to the type of the object and its relative speed with respect to the host vehicle and then the traveling is controlled to achieve the lateral movement amount that has been set. Japanese Patent Application Publication No. 2013-171439 (JP 2013-171439 A) proposes a driving assistance device that determines whether to perform driving assistance control and a driving assistance method (deceleration, steering), based on a change in the degree of approach to an object detected in front of a traveling vehicle and a change in the driving operation. In addition, a driving assistance system, called an autonomous emergency braking system, is proposed. In this system, when a moving object that runs into the traveling path of a traveling vehicle is detected, a warning that prompts the driver to apply the brake is presented and, if it is determined that the driver does not take a corresponding action, the system applies the autonomous collision avoidance brake. In addition, in “Development of driving assistance system for predicting danger when passing pedestrians in a narrow road” by Tuyuki Hajime and two other authors, public interest incorporated association Society of Automobile Engineers of Japan, Academic lecture pre-printed paper 201357382013, a system is proposed that autonomously decelerates or accelerates a vehicle when a moving object is detected near the roadside of the road (roadside) while the vehicle is traveling and, thereby, avoids contact with the moving object even when the moving object runs into the center of the road.

### SUMMARY

Many of autonomous emergency braking systems (hereinafter sometimes referred to as AEB) or other collision avoidance systems are configured to detect a moving object that runs into a road and to perform the deceleration and/or steering operation when the risk of contact with the host vehicle becomes obvious. In such a configuration, because a certain amount of time is required for the system (machine) to acquire and analyze the information on the surrounding environment, the deceleration and/or steering operation may not be achieved to a desired extent, for example, when a moving object that has been running near the roadside of the road suddenly runs into the road. On the other hand, the system, such as the one described in “Development of driving assistance system for predicting danger when passing pedestrians in a narrow road” by Tuyuki Hajime and two other authors, public interest incorporated association Society of Automobile Engineers of Japan, Academic lecture pre-printed paper 201357382013, assumes that, when the system finds a moving object that is present or moving on the roadside, the moving object may run into the center of the road (that is, the moving object is going to cross the road) and, before the moving object actually crosses the road, causes the host vehicle to decelerate or accelerate to avoid contact with the moving object. According to this configuration, even if a moving object that is present on the roadside suddenly crosses a road, the AEB operates properly to allow the host vehicle to decelerate to a range of speed at which the host vehicle can stop before the moving object that has entered the road or to pass the moving object before the moving object reaches the passing area of the host vehicle. Therefore, the system is expected to securely avoid contact with a moving object.

However, the system described above performs the motion control of a vehicle, such as deceleration or steering (hereinafter, this control is referred to as “driving assistance control based on prediction of potential risk”), based only on the assumption that, upon detecting a moving object on the road, there is a risk (potential risk) that the moving object may cross the road. This control results in an operation in which, when the moving object approaches the center of the road, that is, before collision between the host vehicle and the moving object becomes obvious, the machine automatically intervenes in the driving of the vehicle based on a programmed determination that is made according to the artificial-intelligent-based potential risk control technology. In addition, a “potential risk” prediction that is made by the system (machine) does not always correspond to a potential risk that is made based on the driver's (human) perception or understanding of the surrounding environment and, in addition, the machine does not always perform the steering or deceleration operation for a potential risk in the same way as the driver. Therefore, there is a possibility that the driver finds it difficult to understand the control operation of the system or that the driver's intention is not reflected at all, with the result that the driver feels discomfort for an operation of the system.

In addition, even if safer vehicle driving can be achieved by the system control, the driver will still feel discomfort if driver's driving is not reflected at all.

The present disclosure provides a driving assistance control device that reduces the driver's discomfort for a system operation as much as possible in a driving assistance system in which “driving assistance control based on prediction of potential risk” based on a “potential risk” while the vehicle is traveling.

A driving assistance control device for a vehicle, according to an aspect of the present disclosure includes: a moving object detection sensor configured to detect a moving object moving along a roadside in a traveling direction of the vehicle; a driving operation detection sensor configured to detect a driving operation of a driver; an actuator; and an Electronic Control Unit configured to perform automatic steering control of the vehicle by the actuator to avoid the moving object based on a detection result of the moving object, the Electronic Control Unit being configured to start the automatic steering control based on a driving steering of the driver after the moving object is detected.

In the configuration described above, a “moving object moving along a roadside” may be a pedestrian or a cyclist walking or running near the roadside of the traveling path of the host vehicle (hereinafter, sometimes referred to as a “moving object”). The “moving object detection sensor” may be any unit, such as an in-vehicle camera or a radar device, that can detect the condition around the vehicle or may be a unit that detects or recognizes a moving object, which moves along the roadside, from the information around the vehicle obtained by the GPS device or the like. The above-mentioned “driving operation” may be any operation related to the driving of a vehicle such as the steering operation or the brake pedal depression performed by the driver. The “driving operation detection unit” may be any unit for detecting whether there is a significant “driving operation”. For example, the “driving operation detection sensor” may be a sensor or a determination circuit for determining whether the steering angle of the steering wheel exceeds a predetermined value or whether the depression amount of the brake pedal exceeds a predetermined amount.

According to the configuration of the device described above, when a “moving object moving along the roadside” is detected while the vehicle is traveling, a prediction is made whether there is a potential risk that the moving object may run into the road and, based on that prediction, the driving assistance control is basically provided for automatically steering the vehicle to avoid contact with the moving object. However, as described above, if such driving assistance control is performed irrespective of the driving operation of the driver, the driver may feel discomfort about the assistance operation performed by the assistance control. Hence, according to the device in the aspect described above, the automatic steering control unit that performs the automatic assist control after the detection of a moving object is configured to perform the automatic steering control by referring to the driving operation of the driver. That is, the driving assistance control is performed, not immediately in response to the detection of the moving object, but by referring to the driving operation of the driver. Because it is expected that the driving intention of the driver is reflected in driving assistance control, automatic steering performed by referring to the driving operation of the driver allows the driving intention of the driver to be reflected in the driving assistance control, resulting in a reduction in the discomfort of the driver.

In the above aspect, the Electronic Control Unit may be configured to start the automatic steering control when a steering operation or a braking operation of the driver is detected after the moving object is detected, or a predetermined time has elapsed after the moving object is detected.

When the driver performs the steering operation or the braking operation, it is estimated that, upon detecting a moving object, the driver predicts a potential risk corresponding to the moving object and intends to move away from the area where there will be a potential risk (the area where a pedestrian who has run into the road will pass), or to decelerate the vehicle, for avoiding collision. In that case, the device of the present disclosure performs automatic steering according to the driver's intention and, therefore, it is expected that the driver's discomfort, caused when the vehicle is steered suddenly by the assistance control, is reduced. On the other hand, if the driver detects a moving object on the roadside but does not perform any driving operation for the potential risk even after a certain time elapses and if the vehicle continues traveling, the risk that the vehicle will come into contact with the moving object, which will occur when the moving object on the roadside runs into the road, is not reduced. Therefore, the automatic steering control may be performed also when the driver does not perform any driving operation for the potential risk even after a predetermined time elapses. In this way, when the driver does not perform an expected driving operation by an expected time and, on behalf of the driver, the system performs steering control suddenly, the driver will find that he or she has been unaware of the moving object when the vehicle is automatically steered as the moving object on the roadside actually comes close to the vehicle. This configuration will therefore reduce the degree of discomfort for automatic steering control as compared when automatic steering control is activated at the same time the moving object is detected.

When the device according to the aspect of the present disclosure detects a moving object on the roadside, the driver does not always recognize the moving object and does not always predict a potential risk. Therefore, the steering control of the vehicle according to the aspect of the present disclosure may be an unexpected steering control to the driver in any case.

Therefore, the aspect of the present disclosure may include a risk presentation unit configured to present to the driver, when the moving object is detected, that there is a risk of crossing by the moving object.

The configuration described above allows the driver to predict a potential risk and to steer or brake the vehicle and, when the automatic steering control is started, prevents the driver from feeing discomfort that the steering wheel is unexpectedly steered. That is, the configuration described above provides the driver with an interface that allows the driver to recognize a potential risk and to know how to respond to the potential risk.

In the above aspect, the risk presentation unit may include a display that visually displays that there is the risk of crossing a traveling path of the vehicle by the moving object, and the risk presentation unit may be configured to represent that the risk of crossing further increases according to at least one of elapse of time and increase of a possibility of the crossing.

As described above, the steering control performed by the device according to the aspect of the present disclosure is the control operation for performing the steering of the vehicle in preparation for the risk that, after detecting a moving object on the roadside, the moving object on the roadside may run into the road. The steering control performed by the device according to the aspect of the present disclosure may be carried out when the movement of the moving object toward the center of the road is not yet detected and, when the moving object actually approaches the center of the road, the contact avoidance operation by the AEB system may be performed as described above. Therefore, the automatic steering control according to the aspect of the present disclosure may be the control operation for the preliminary steering of the vehicle, which is performed when the moving object on the roadside is detected, in order to more surely avoid contact with the moving object when the moving object actually runs into the road. In that case, it is preferable that the vehicle position when the operation of the AEB system for avoiding contact with the moving object is started or when the driver starts the steering or braking operation be set at a position where the distance from the moving object is sufficient for avoiding contact with the moving object. The amount of steering, required for moving the vehicle from the current position to that position, depends on the relative distance between the area in the traveling path, where the moving object on the roadside is assumed to reach in the traveling path of the vehicle, and the vehicle.

The study by the inventors of the present application shows the following condition. That is, when a moving object that is moving on the roadside ahead of the road in the traveling direction of the vehicle moves from the roadside toward the center of the road while the vehicle is traveling, the condition for traveling in the same direction without steering and then passing the moving object without coming into contact with it or for braking to a vehicle speed for stopping before the moving object (hereinafter referred to as “safe vehicle speed”) is expressed as a function of the relative position between the vehicle and the moving object. Therefore, to perform automatic steering control for preventing the vehicle from coming into contact with a moving object even if the moving object on the roadside moves to the center of the road, the traveling path of the vehicle should be changed in a direction getting away from the current position of the moving object compared with the traveling path of the original route when automatic control is not performed, if the vehicle speed exceeds the safe vehicle speed.

Therefore, in the aspect of the present disclosure, the Electronic Control Unit may be configured to: determine a safe vehicle speed of the vehicle as a function of a relative position between the vehicle and the moving object, the safe vehicle speed of the vehicle being a speed with which a contact between the vehicle and the moving object is avoided when it is assumed that the moving object enters a traveling path of the vehicle; set a target route when a vehicle speed of the vehicle exceeds the safe vehicle speed, the target route being a route along which the vehicle travels in a direction further away from a current position of the moving object than current course of the vehicle; and to perform the automatic steering control by the actuator so that the vehicle travels along the target route.

Further, the aspect of the present disclosure may include a brake actuator, and the Electronic Control Unit may be configured to: perform deceleration control of the vehicle by the brake actuator when the moving object enters a traveling path of the vehicle; determine a safe vehicle speed as a function of a relative position between the vehicle and the moving object, the safe vehicle speed being a maximum value of a speed of the vehicle with which a contact between the vehicle and the moving object is avoided by the deceleration control when it is assumed that the moving object enters the traveling path of the vehicle; set a target route when a vehicle speed of the vehicle exceeds the safe vehicle speed, the target route being a route along which the vehicle travels in a direction further away from a current position of the moving object than a current course of the vehicle; and perform the automatic steering control so that the vehicle travels along the target route.

If the steering operation of the driver is reflected in the motion of the vehicle when the driver is also performing the steering operation during automatic steering control for causing the vehicle to travel along the target route, it is thought that the discomfort of the driver for the automatic steering control can be reduced. In addition, if automatic steering control is performed and, in addition, the steering operation by a driver is performed, the steering operation is performed to a degree exceeding the driver's assumption and there is a possibility that the driver feels discomfort.

Therefore, in the above aspect, in the automatic steering control, the Electronic Control Unit may be configured to provide steering torque to compensate for a difference between target steering torque to travel along the target route and driver steering torque given by a steering operation of the driver.

The configuration described above allows the driver to feel that his/her own steering is reflected and, at the same time, to achieve the steering control of the vehicle based on the target route.

Furthermore, in the automatic steering control for causing the vehicle to travel along the target route described above, when the steering torque, which is given momentarily to the vehicle, is set as the steering torque that is given when the vehicle is driven by a normative driver (that is, a driver who performs ideal driving), it is expected that ideal vehicle motion will be realized.

Therefore, in the above aspect, the target steering torque may be determined based on a steering angle given to a steering wheel of the vehicle during a steering operation performed when a normative driver moves the vehicle along the target route.

The aspect of the present disclosure may include a transmitting unit configured to transmit displacement or torque to a steering wheel of the vehicle for informing the driver about a start of the automatic steering control when the automatic steering control by the Electronic Control Unit is started.

The configuration described above allows the driver to know, at the start of automatic steering control, that the device will start automatic steering.

Thus, according to the device in the aspect of the present disclosure, the driving assistance control, designed based on the prediction of a potential risk that a moving object may run into the road when it is found on the roadside, is performed in such a way that, after the moving object is detected, the system performs the automatic steering control by referring to the driving operation of the driver. The automatic steering control performed in this way increases the degree of driver's involvement in the driving of the vehicle and, at the same time, reduces the driver's discomfort caused by the braking operation. That is, after a moving object is detected on the roadside, the automatic steering control not is started immediately regardless of whether the driver is performing the driving operation but is started either when the driver performs the steering operation or the braking operation or when a predetermined time elapses. This automatic steering control refers to (monitors) the driving of the driver after the detection of a moving object on the roadside so that the driving intention of the driver is reflected in the automatic steering control, thus ensuring a high level of cooperation between the driver (human) and the device (machine).

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1A is a schematic diagram showing a vehicle on which a driving assistance control device for a vehicle in an embodiment of the present disclosure is mounted;

FIG. 1B is a block diagram showing a configuration of a system in the driving assistance control device for a vehicle in an embodiment of the present disclosure;

FIG. 2A is a schematic diagram showing a situation in which driving assistance is performed by the driving assistance control device for a vehicle in an embodiment of the present disclosure;

FIG. 2B is a flowchart showing the processing in the driving assistance control device for a vehicle in an embodiment of the present disclosure;

FIG. 3A is a diagram schematically showing an example of a risk display that, after the detection of a moving object on the roadside during the traveling of a vehicle, represents the presence of a potential risk (moving object crosses the road) provided for visual presentation to the driver in the driving assistance control device for a vehicle in an embodiment of the present disclosure;

FIG. 3B is a display presented when automatic steering control is being performed and ended in the driving assistance control device for a vehicle in an embodiment of the present disclosure;

FIG. 3C is a diagram showing how displacement or torque, applied for informing a driver about the automatic steering control, is given to the steering wheel of a vehicle when automatic steering control is started by an automatic steering control unit in the driving assistance control device for a vehicle in an embodiment of the present disclosure;

FIG. 3D is a diagram schematically showing an example (right) of a display presented when a moving object is detected on the roadside and then the detected moving object actually crosses the road in the driving assistance control device for a vehicle in an embodiment of the present disclosure;

FIG. 4A is a diagram schematically showing an example of a change over time in the display of a potential risk, the steering angle of a vehicle, and the steering torque as a result of the processing in FIG. 2B when a driver's driving operation is performed after a moving object is detected on the roadside and before a predetermined time elapses;

FIG. 4B is a diagram schematically showing an example of a change over time in the display of a potential risk, the steering angle of a vehicle, and the steering torque as a result of the processing in FIG. 2B when a driver's driving operation for a moving object on the roadside is not performed for a predetermined time after a moving object is detected;

FIG. 5A is a schematic diagram showing a situation in which automatic steering control is performed, and a diagram showing parameters referenced during the calculation of a safe vehicle speed, in the driving assistance control device for a vehicle in an embodiment of the present disclosure;

FIG. 5B is a diagram showing the safe vehicle speed, in a map format, that is expressed with the relative distance between the vehicle and a moving object as a variable;

FIG. 5C is a diagram showing a target route determined by referring to the safe vehicle speed map; and

FIG. 5D is a top view of a vehicle being steered and shows the parameters of a look-ahead model used in determining the target steering angle for the movement of the vehicle along the target route.

### DETAILED DESCRIPTION OF EMBODIMENTS

Vehicle Configuration

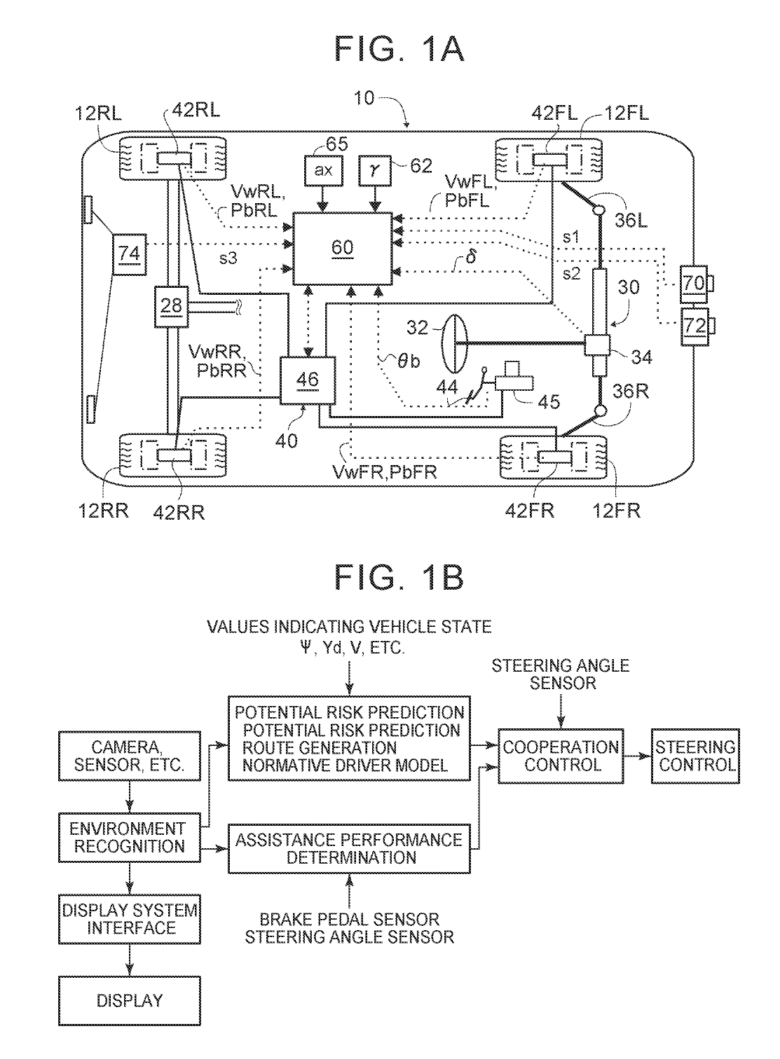

Referring to FIG. 1A, a vehicle 10 such as an automobile in which a driving assistance control device according to the present disclosure is incorporated includes the following: left and right front wheels 12FL and 12FR, left and right rear wheels 12RL and 12RR, a driving system device (only a part is shown) that generates driving force for the wheels (only for the rear wheels in the example shown in the figure because the vehicle is a rear-wheel drive vehicle) according to the driver's depression of the accelerator pedal, a steering device 30 for controlling the steering angle of the front wheels (furthermore, a steering device for the rear wheels may be provided), and a braking system device 40 for generating braking force on the wheels. In the standard mode, the driving system device is configured to transmit driving torque or rotational force from the engine and/or the electric motor (not shown; a hybrid driving device having both an engine and a motor may also be used) to the rear wheels 12RL and 12RR via the transmission (not shown) and a differential gear unit 28. For the steering device 30, a power steering apparatus, which transmits the rotation of a steering wheel (handle) 32, operated by the driver, to tie rods 36L, 36R while boosting its rotation torque by a booster 34 to rotate the front wheels 12FL, 12FR, may be used. In particular, because automatic steering control is performed in this embodiment under a predetermined condition after a moving object is detected on the roadside, the booster 34 having a configuration, capable of giving steering torque based on a command from an electronic control unit 60, is used.

The braking system device 40 is an electronically controlled hydraulic braking device that adjusts the brake pressure in wheel cylinders 42i (i=FL, FR, RL, RR; the same notation applies hereafter), provided in the wheels (that is, the braking force in the wheels), by means of a hydraulic circuit 46 that communicates with a master cylinder that operates in response to the depression of a brake pedal 44 depressed by the driver. The hydraulic circuit 46 has various valves (master cylinder cut valve, hydraulic pressure holding valve, pressure reducing valve) that allow the wheel cylinder of each wheel to selectively communicate with the master cylinder, oil pump, or oil reservoir (not shown). In the normal operation, the pressure of a master cylinder 45 is supplied to the respective wheel cylinders 42i in response to the depression of the brake pedal 44. As will be described later, when automatic steering control is performed after detecting a moving object on the road side, the booster 34 gives steering torque based on a command from the electronic control unit 60.

The vehicle 10, on which the driving assistance control device in this embodiment is used, may have an in-vehicle camera 70 and a radar device 72 that detect the circumstances around the vehicle for detecting other vehicles around the vehicle, obstacles, moving objects (pedestrian, cyclist), road width, and buildings. In addition, the vehicle 10 may have a GPS device (car navigation system) that communicates GPS satellites to acquire various types of information such as the information on the surrounding condition and the position information.

The electronic control unit 60 controls the operation of the units of the vehicle described above and the operation of the driving assistance control device in this embodiment. The electronic control unit 60 may include a microcomputer, which has a CPU, a ROM, a RAM and an input/output port devices interconnected by a two-way common bus in a normal form, and a driving circuit. The configuration and operation of each unit of the driving assistance control device in this embodiment, which will be describe later, may be realized by the operation of the electronic control device (computer) 60 according to the program. The electronic control unit 60 receives the detection values from various sensors for use as parameters for the driving assistance control of this embodiment executed in the mode that will be described later. The detection values described above include information s1 to s3 from the in-vehicle camera 70, the radar device 72, and a GPS device 74, the depression amount θb of the brake pedal, the steering angle δ, the detection value ax of a longitudinal G sensor 65, and the wheel speed Vwi (i=FL, FR, RL, RR). The electronic control unit 60 outputs a control command, which presents a risk indication to the driver, and a control command, which indicates a control amount used in automatic steering control, to the corresponding devices. Although not shown, the electronic control unit 60 may receive various parameters required for various types of control to be executed in the vehicle in this embodiment (for example, various detection signals such as the yaw rate γ and/or lateral acceleration Yg from a gyro sensor 62) and may output various control commands to the corresponding devices.

Device Configuration

As shown in FIG. 1B, the driving assistance control device in this embodiment is configured by an environment recognition unit, a display system interface unit, a potential risk prediction unit, an assistance execution determination unit, and a cooperation control unit. The environment recognition unit recognizes the situation around the vehicle based on the information received from the camera and the sensors. When the presence of a moving object is detected on the roadside, the environment recognition unit sends that information to the display system interface unit, potential risk prediction unit, and assistance execution determination unit, respectively. The display system interface unit presents a risk display on the in-vehicle display in the mode that will be described later. The potential risk prediction unit uses a driver model, created by modeling after the driving behavior of a normative driver, to calculate the target steering angle for use in automatic steering control and the control amount for realizing the target steering angle, based on the position information on a moving object and the state of the host vehicle (vehicle speed, etc.) in the mode that will be described later. After receiving the information on the presence of the moving object on the roadside, the assistance execution determination unit monitors the driving operation of the driver in the mode that will be described later, determines a time at which automatic steering control is to be executed and, after the execution of automatic steering control is determined, sends that information to the cooperation control unit. The cooperation control unit determines a control command based on the control amount for the automatic steering control determined by the potential risk prediction unit and the driving operation (steering operation) performed by the driver and, then, sends the control command to the steering control device. The assistance execution determination unit may be configured to control the transmission of the information on the start of the automatic steering control to the driver according to the the displacement of the steering wheel in the mode that will be described later when the automatic steering control is started.

Device Operation

### (1) Outline of Assistance Control

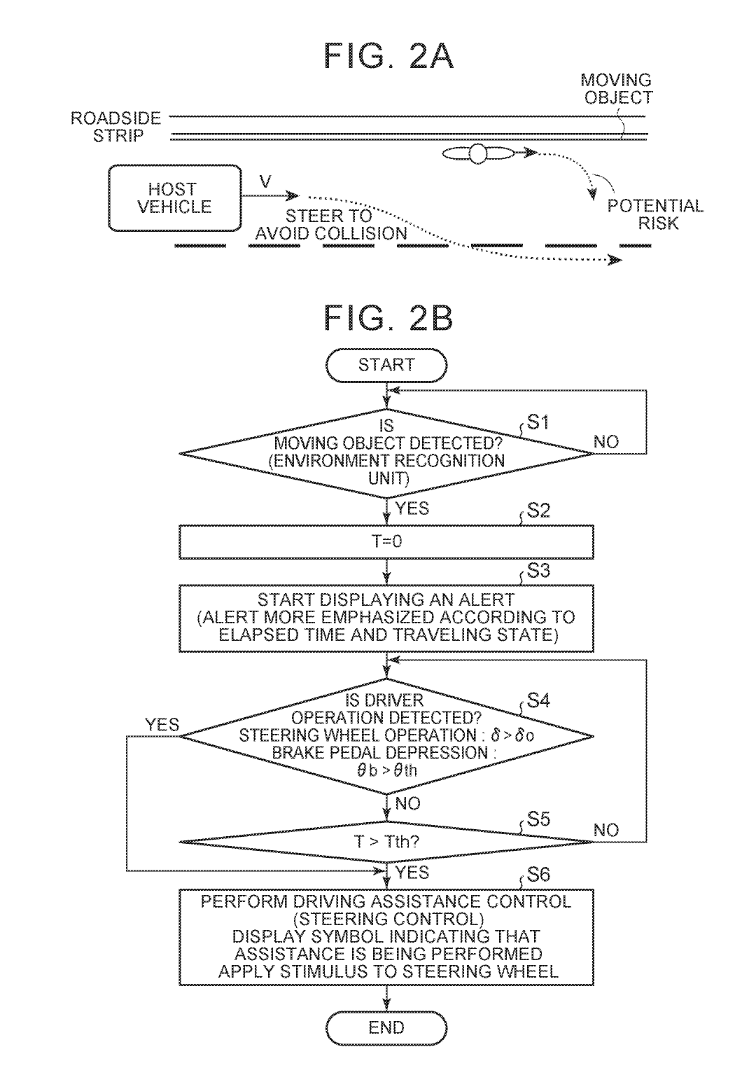

FIG. 2A schematically shows the operation of the driving assistance control device in this embodiment. First, when a moving object (cyclist, pedestrian), which is moving along the roadside near the roadside strip, is recognized while the vehicle (host vehicle) is traveling, a potential risk is assumed that the moving object may run into, and cross, the road and, in preparation for this potential risk, the host vehicle is automatically steered. However, if the device simply performs the automatic steering control immediately after the moving object corresponding to the potential risk is detected, the intention and operation of the device control is not understood by the driver or is different from the driver's intention. In this case, there is a possibility that the driving operation of the driver is not reflected and, as a result, the driver may feel discomfort about the control operation of the device. To address this problem, the driving assistance control of the device in this embodiment does not perform the automatic steering control immediately after the presence of a moving object is detected or recognized. Instead, the device in this embodiment presents the information to the driver indicating that there is a potential risk and, at the same time, monitors the driver's driving operation. After that, upon recognizing that the driver starts the steering operation or the braking operation to avoid the potential risk, the device may start the automatic steering control accordingly. In addition, if the driver does not perform the steering operation or the braking operation even after a predetermined time elapses from the detection of the presence of a moving object, the device may perform the automatic steering control.

(2) Control Flow

FIG. 2B shows the processing operation of the driving assistance control performed by the device in this embodiment. First, while the vehicle is traveling, the environment recognition unit monitors the surrounding condition of the vehicle to detect a moving object on the roadside (step 1). The environment recognition unit may monitor the surrounding condition of the vehicle in an arbitrary manner using the units, such as the in-vehicle camera 70, radar device 72, and GPS device 74, for collecting the information on the surroundings of the vehicle. If a moving object is recognized on the roadside based on the information obtained by the camera and other units, it may be determined that there is a moving object that will become a potential risk.

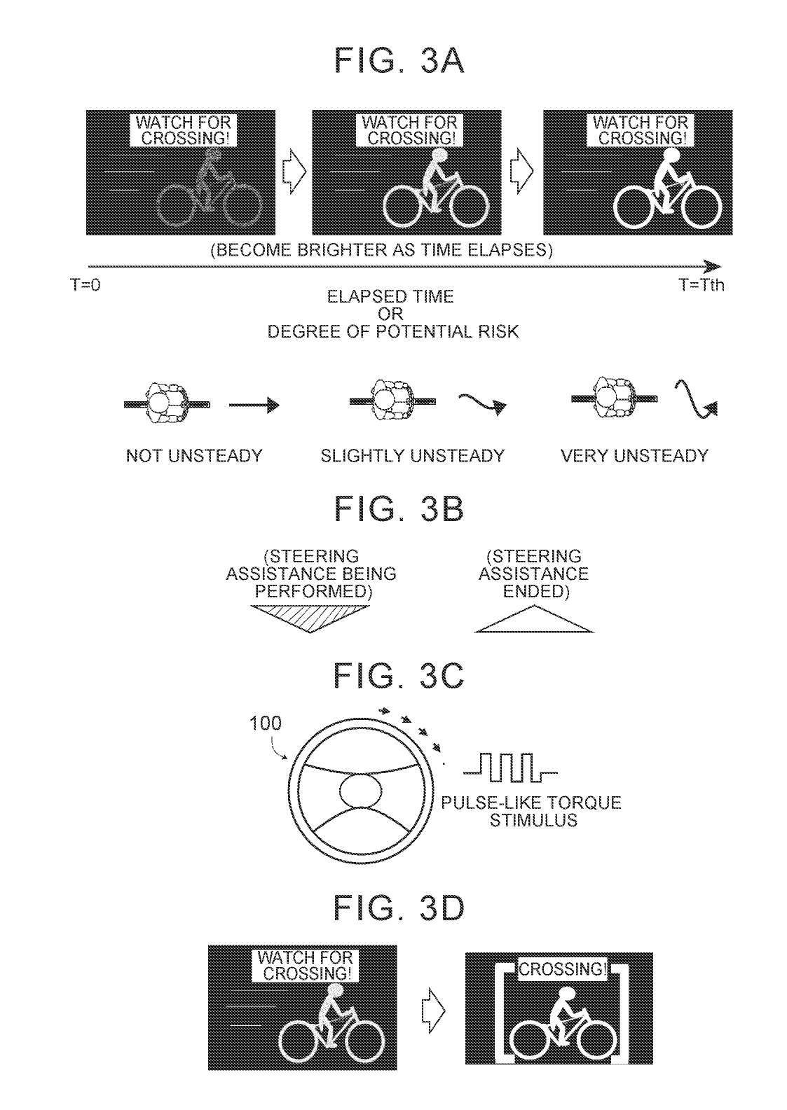

If it is determined that there is a moving object, the time T, which represents the elapsed time from the time the moving object is detected, is reset to T=0. After that, while measuring the elapsed time T (steps 2 to 5), the device starts the display of an alert for presenting a potential risk, generated by the presence of the moving object, to the driver (step 3) and, at the same time, monitors the driving operation of the driver (step 4). For example, the alert display processing is performed in such a way that a visual display for alerting the driver to the crossing of the moving object is presented on the display (not shown), arranged near the dashboard in the front of the driver's seat, as shown FIG. 3A. In that case, the display may preferably be emphasized by increasing the display brightness or the blinking rate to indicate that, as the time elapses from the time immediately after the detection of the moving object, the degree of the potential risk gradually increases. In addition, the degree of the potential risk increases according to the movement state of the moving object. For example, the degree of the potential risk increases as the degree of unsteady riding is higher, as the moving speed is slower, the position of the moving object closer to the center of the road, and the number of moving objects (such as the number of cyclists running in parallel) is larger. Therefore, to reflect the movement state of the moving object, the display may be more emphasized. This configuration allows the driver to be aware that the device has also recognized the presence of the potential risk, thus notifying the driver about the intention of the device for the control.

The device monitors the driving operation of the driver as follows (step 4). The device monitors whether the driver has performed a driving operation for avoiding the potential risk, that is, whether the driver has turned the steering wheel operation or has depressed the brake pedal. For example, if the change amount of the steering angle δ of the steering wheel exceeds the predetermined angle δo in the direction away from the moving object or if the depression amount θb of the brake pedal exceeds the predetermined value θth, it may be determined that the driving operation for avoiding the potential risk has been performed.

If the driving operation of the driver for avoiding the potential risk is detected as described above, the automatic steering control is performed in response thereto in the mode that will be described later (step 6). In addition, if the alert is displayed but a driving operation for avoiding the potential risk is not performed and if the elapsed time T exceeds the predetermined value Tth, the device determines that there is a need for the automatic steering control and performs the automatic steering control. While the automatic steering control is performed, the display indicating that the steering control is being performed may be displayed at an arbitrary position on the dashboard in front of the driver's seat as shown in the left half of FIG. 3B. When the automatic steering control is ended, the display indicating that the automatic steering control has been ended may be presented as shown in the right half of FIG. 3B.

In addition, before the automatic steering control is started, a stimulus may be applied to the steering wheel, held by the driver, to inform the driver that the automatic steering control will be started. For example, as schematically shown in FIG. 3C, a pulse-like torque or a vibration may be given to the steering wheel. This torque or vibration informs the driver about the operation intention of the device using a non-visual method, thus improving communication between the device and the driver and reducing the driver's discomfort.

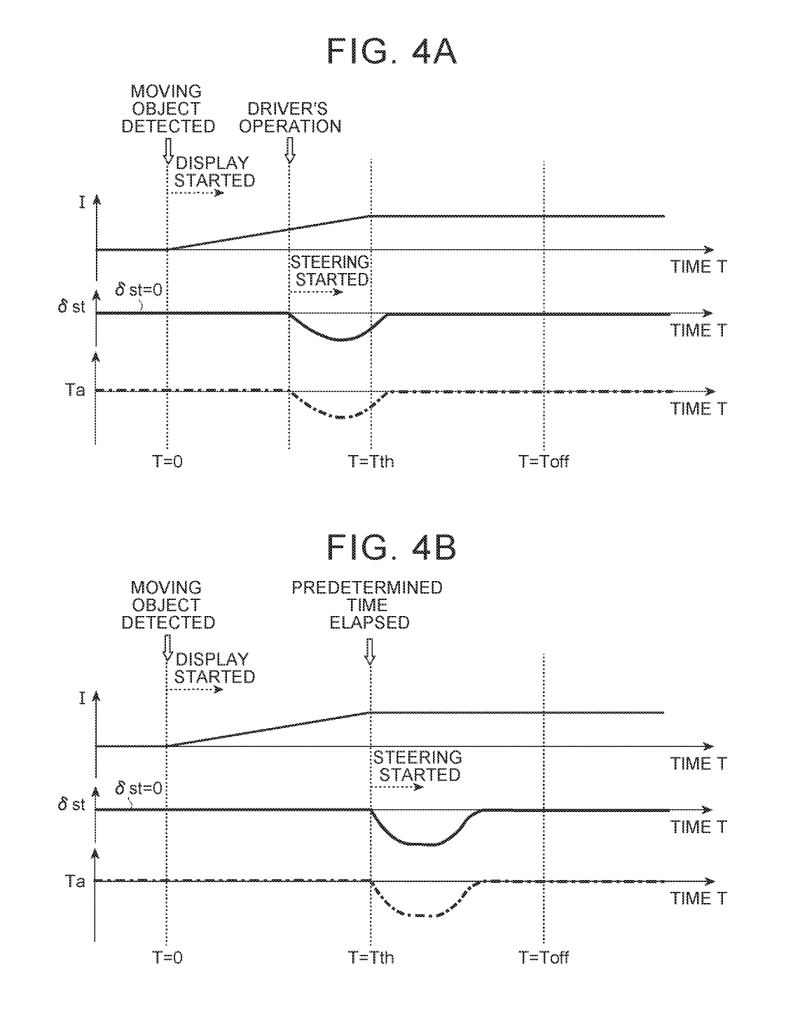

Referring to FIGS. 4A and 4B, a sequence of the control described above is summarized as follows. First, when a moving object is detected on the roadside while the vehicle is traveling, T is reset to 0. Next, the alert display is started, with the display gradually emphasized such that the brightness or the blinking speed I increases with the lapse of time to allow the driver to more reliably recognize and understand the potential risk detected by the device. After that, if a driving operation of the driver is detected, the automatic steering control is performed from that point as shown in FIG. 4A, with the result that the steering angle δst is changed and the steering torque Ta is increased. On the other hand, if the elapsed time T from the detection of the moving object on the roadside reaches Th but if the driver has not yet performed any driving operation, the automatic steering control is performed from that point, as shown in FIG. 4B, with the result that the steering angle δst is changed and the steering torque Ta is increased.

If the moving object actually has started crossing the road while the series of control operations described above is being performed or after the automatic steering control is completed, the AEB system may perform the deceleration control or the driver may perform the steering operation or the braking operation. In that case, as shown in FIG. 3D, the alert display may be changed from the display representing a potential risk to the display representing an obvious risk (crossing of the moving object).

(3) Automatic Steering Control

The automatic steering control performed by the device in this embodiment is as shown in FIGS. 2A and 2B. That is, the control is performed in such a way that, when a moving object is detected on the roadside, the device predicts a risk that the moving object may enter the traveling path of the vehicle and, before it is not yet detected that the moving object has entered the traveling path, controls the steering of the vehicle in advance. In fact, it is expected that a normative driver will perform the operation as follows. For example, when a moving object is detected in the situation shown in FIG. 2A, a normative driver will predict a risk that the moving object may enter the traveling path and that, even if the moving object has not yet entered the traveling path, will steer the vehicle so that a contact with the moving object can be avoided more reliably when the moving object actually enters the traveling path. The automatic steering control in this embodiment is realized by simulating the driving of such a normative driver.

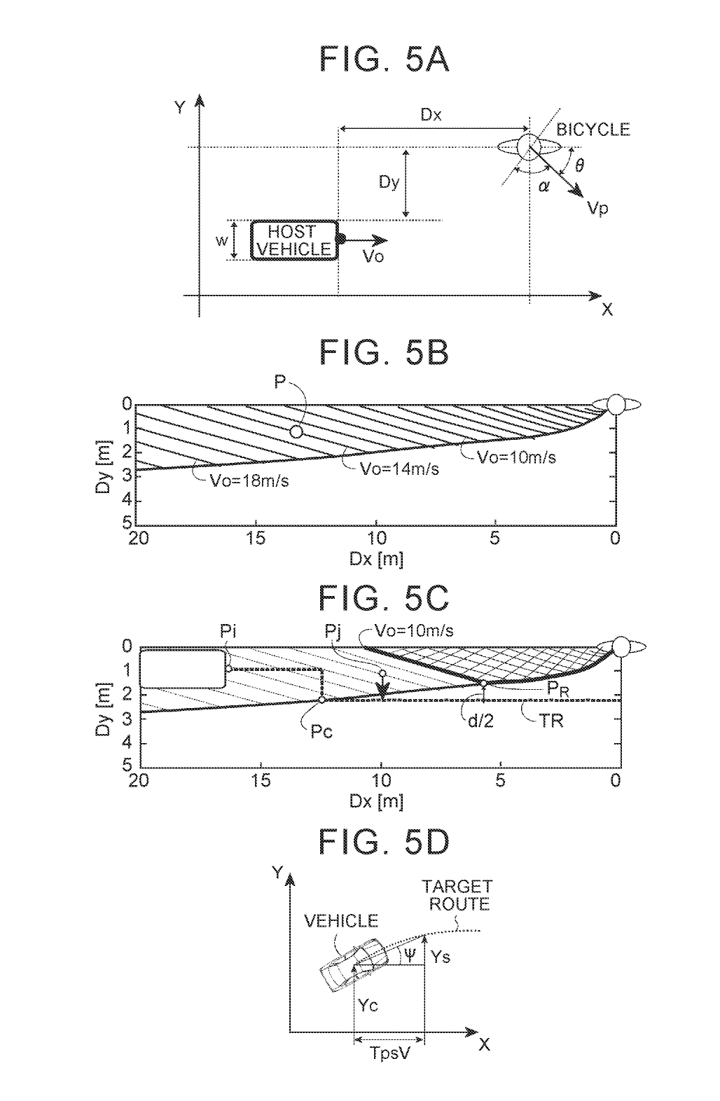

In the automatic steering control, steering control assistance based on a potential risk prediction driver model is performed. In this case, the steering control assistance system includes an environment recognition unit, a potential risk prediction driver model unit, and an assistance performance determination unit, as shown in FIG. 1B. In the potential risk prediction driver model, the speed of collision with the cyclist is defined as the potential risk in a scene where a cyclist may cross the road suddenly. In the potential risk prediction scheme given below, a mathematical model assuming that cyclist will suddenly cross the road is set. This model assumes that “a cyclist will start crossing a road at a particular time under the constraints of a particular crossing angle range and a particular speed range” (See FIG. 5A).

In the description below, let Vo be the speed of the host vehicle, let w be the width of the host vehicle, let Dx be the relative front-to-back distance between the left front end of the host vehicle and the bicycle when the cyclist starts crossing the road, and let Dy be the relative lateral distance. In addition, let Vp, θ, and α be the crossing angle, crossing speed, and viewing angle of the cyclist, respectively. It is assumed that the cyclist will suddenly cross the road only when the host vehicle is not included in the field of view of the cyclist. The host vehicle speed for avoiding collision with the suddenly-crossing cyclist can be kinematically expressed by the following expressions (1) to (4). [When the host vehicle passes in front of the cyclist at a constant speed]

$$\begin{matrix}[ Expression 1 ] & \\ Vo ≻ \frac{Dx}{Dy} Vp sin θ + Vp cos θ & ( 1 )\end{matrix}$$

### [When the Host Vehicle Decelerates to Avoid Collision]

$$\begin{matrix}[ Expression 2 ] & \\ Vo ≺ \{ \begin{matrix}Vp cos θ - {α}_{d} {τ}_{b} + \sqrt{{α}_{d}^{2} {τ}_{b}^{2} + 2 {α}_{d} Dx} ( Vp sin θ \leq {Λ}_{1} ) \\ \frac{{a}_{d} ( Dy + w )}{2 Vp sin θ} + \frac{Vp sin θ}{Dy + w} ( Dx + \frac{1}{2} {α}_{d} {τ}_{b} ) + \\ Vp cos θ - {α}_{d} {τ}_{b} ( {Λ}_{1} ≺ Vp sin θ \leq {Λ}_{2} ) \\ \frac{Dx}{Dy + w} Vp sin θ + Vp cos θ ( {Λ}_{2} ≺ Vp sin θ )\end{matrix} & ( 2 )\end{matrix}$$

where

$$\begin{matrix}[ Expression 3 ] & \\ {Λ}_{1} = ( Dy + w ) \sqrt{\frac{{a}_{d}}{{α}_{d} {τ}_{b}^{2} + 2 Dx}} & ( 3 ) \\ [ Expression 4 ] & \\ {Λ}_{2} = \frac{Dy + w}{{τ}_{b}} . & ( 4 )\end{matrix}$$

The right side of expression (1) means the minimum value of the host vehicle speed necessary for avoiding collision by passing the cyclist before the cyclist enters the traveling path of the vehicle, when the cyclist suddenly starts crossing the road. The right side of expression (2) means the maximum value of the host vehicle speed at which collision can be avoided by operating the AEB, when the cyclist suddenly starts crossing the road. In the expression, τb is the reaction time of AEB and ad is the deceleration of AEB. From the above, it is necessary to travel at a host vehicle speed that satisfies expression (1) or (2) for avoiding collision with the cyclist.

If there is a combination of Vp and θ that does not satisfy either of expressions (1) and (2) when the crossing speed of the cyclist is varied in the range of 0≦Vp≦Vpmax (upper and lower limits of the crossing speed) and when the crossing angle of the cyclist is varied in the range of 0≦θ≦θmax (upper and lower limits of the traverse angle), there is a possibility that the host vehicle cannot avoid collision with the cyclist. With the maximum value of the host vehicle speed at that time as the maximum safe speed, the relationship between the maximum safe speed and the relative position between the vehicle and the cyclist is defined as a safe speed map. The safety speed map is shown in FIG. 5B. There is a possibility of collision when the host vehicle enters the area indicated by the contour lines of the host vehicle speed Vo in the figure.

From the safe speed map, the route generation unit determines the lateral interval to be secured by the host vehicle and generates a target route. As shown in FIG. 5C, entry into the potential risk area is prevented by offsetting the target trajectory from the center of the lane. At this time, the car width is also taken into consideration.

The normative steering angle output method model of a normative driver model unit is given by the following expression (5).

$$\begin{matrix}[ Expression 5 ] & \\ {θ}_{sw}^{*} = \frac{{h}_{s}}{1 + {T}_{n s} s} \{ {Y}_{s} - ( {Y}_{c} + {T}_{p s} V ψ ) \} & ( 5 )\end{matrix}$$

where, θsw* is the normative steering wheel angle, hs is the normative driver steering gain, Tns is the first-order lag time constant, Ys is the normative driver target lateral displacement, Yc is the actual lateral displacement, Tps is the normative driver's look-ahead time, V is the vehicle speed, and Ψ is the vehicle yaw angle. (see FIG. 5D).

The assist torque corresponding to the above-mentioned normative steering angle is determined by expression (6) given below.

$$\begin{matrix}[ Expression 6 ] & \\ {T}_{a} ( t ) = \{ \begin{matrix}{K}_{a} ( {θ}_{sw}^{*} ( t ) - {θ}_{sw} ( t ) ) & if {Y}_{s}^{*} - {Y}_{s} ( t ) \geq 0 \\ 0 & otherwise\end{matrix} & ( 6 )\end{matrix}$$

Assistance will not be performed when the position of the look-ahead point exceeds the position of the target trajectory Ys* of the assistance system. That is, the assistance is steering assistance, not for trajectory tracking, but for preventing only entry into a potential risk area.

Although the embodiments of the present disclosure have been described above, many modifications and changes are easily made by those skilled in the art. It is apparent that the present disclosure is not limited only to the embodiments described above but is applicable to various devices without departing from the concept of present disclosure.

What is claimed is:

1. A driving assistance control device for a vehicle comprising:
a moving object detection sensor configured to detect a moving object moving along a roadside in a traveling direction of the vehicle;
a driving operation detection sensor configured to detect a driving operation of a driver;
an actuator; and
an Electronic Control Unit configured to perform automatic steering control of the vehicle by the actuator to avoid the moving object based on a detection result of the moving object, the Electronic Control Unit being configured to start the automatic steering control based on a driving steering of the driver after the moving object is detected.

2. The driving assistance control device for the vehicle according to claim 1, wherein the Electronic Control Unit is configured to start the automatic steering control when
a steering operation or a braking operation of the driver is detected after the moving object is detected, or
a predetermined time has elapsed after the moving object is detected.

3. The driving assistance control device for the vehicle according to claim 1, further comprising
a risk presentation unit configured to present to the driver, when the moving object is detected, that there is a risk of crossing by the moving object.

4. The driving assistance control device for the vehicle according to claim 3, wherein
the risk presentation unit includes a display that visually displays that there is the risk of crossing a traveling path of the vehicle by the moving object, and
the risk presentation unit is configured to represent that the risk of crossing further increases according to at least one of elapse of time and increase of a possibility of the crossing.

5. The driving assistance control device for the vehicle according to claim 1, wherein the Electronic Control Unit is configured
to determine a safe vehicle speed of the vehicle as a function of a relative position between the vehicle and the moving object, the safe vehicle speed of the vehicle being a speed with which a contact between the vehicle and the moving object is avoided when it is assumed that the moving object enters a traveling path of the vehicle,
to set a target route when a vehicle speed of the vehicle exceeds the safe vehicle speed, the target route being a route along which the vehicle travels in a direction further away from a current position of the moving object than current course of the vehicle, and
to perform the automatic steering control by the actuator so that the vehicle travels along the target route.

6. The driving assistance control device for the vehicle according to claim 1, further comprising
a brake actuator, wherein
the Electronic Control Unit is configured
to perform deceleration control of the vehicle by the brake actuator when the moving object enters a traveling path of the vehicle,
to determine a safe vehicle speed as a function of a relative position between the vehicle and the moving object, the safe vehicle speed being a maximum value of a speed of the vehicle with which a contact between the vehicle and the moving object is avoided by the deceleration control when it is assumed that the moving object enters the traveling path of the vehicle,
to set a target route when a vehicle speed of the vehicle exceeds the safe vehicle speed, the target route being a route along which the vehicle travels in a direction further away from a current position of the moving object than a current course of the vehicle, and
to perform the automatic steering control so that the vehicle travels along the target route.

7. The driving assistance control device for the vehicle according to claim 5, wherein
in the automatic steering control, the Electronic Control Unit is configured to provide steering torque to compensate for a difference between target steering torque to travel along the target route and driver steering torque given by a steering operation of the driver.

8. The driving assistance control device for the vehicle according to claim 7, wherein
the target steering torque is determined based on a steering angle given to a steering wheel of the vehicle during a steering operation performed when a normative driver moves the vehicle along the target route.

9. The driving assistance control device for the vehicle according to claim 1, further comprising
a transmitting unit configured to transmit displacement or torque to a steering wheel of the vehicle for informing the driver about a start of the automatic steering control when the automatic steering control by the Electronic Control Unit is started.
